(19) United States
(12) Patent Application Publication
(10) Pub. No.: US 2012/0148921 A1
(43) Pub. Date: Jun. 14, 2012

(54) ELECTRODE FOR ENERGY STORAGE DEVICE, METHOD OF MANUFACTURING THE SAME, AND ENERGY STORAGE DEVICE USING THE SAME

(75) Inventors: Sang Kyun Lee, Suwon (KR); Bae Kyun Kim, Seongnam (KR); Ji Sung Cho, Suwon (KR)

(73) Assignee: SAMSUNG ELECTRO-MECHANICS CO., LTD.

(21) Appl. No.: 13/112,243

(22) Filed: May 20, 2011

(30) Foreign Application Priority Data
Dec. 10, 2010 (KR) 10-2010-0126219

(51) Int. Cl. H01M 4/583; H01M 4/04; B32B 38/08; H01G 9/155; H01G 9/145; B05D 5/12; H01M 4/62; H01M 4/66; H01G 9/042; H01G 9/15; B82Y 40/00; B82Y 30/00; B82Y 99/00

(52) U.S. Cl. 429/231.7; 156/242; 361/502; 361/503; 361/523; 427/126.1; 429/231.8; 429/232; 429/245; 977/742; 977/762; 977/948; 977/842

(57) ABSTRACT

Disclosed are an electrode for a low-resistance energy storage device, a method of manufacturing the same, and an energy storage device using the same. In detail, the electrode for an energy storage device is manufactured by forming electrode materials on a metal layer having a dendrite formed thereon. The energy storage device using the electrode for an energy storage device has low resistance characteristics.

### CROSS-REFERENCE TO RELATED APPLICATIONS

This application claims the priority of Korean Patent Application No. 10-2010-0126219 filed on Dec. 10, 2010, in the Korean Intellectual Property Office, the disclosure of which is incorporated herein by reference.

### BACKGROUND OF THE INVENTION

1. Field of the Invention

The present invention relates to an electrode for an energy storage device, a method of manufacturing the same, and an energy storage device using the same, and more particularly, to an electrode for an energy storage device having low-resistance characteristics, a method of manufacturing the same, and an energy storage device using the same.

2. Description of the Related Art

An electric double layer capacitor (EDLC) has mainly been used for stably supplying power to multi-functional electronic products, electric vehicles, as well as home and industrial electronic devices.

The electric double layer capacitor is a capacitor storing electrical energy through an electrostatic charge phenomenon that is generated from an electric double layer formed at an interface between a solid and an electrolyte.

As the electric double layer capacitor has characteristics capable of rapidly charging and discharging high-density energy, it has been prevalently used as an auxiliary power supply or as a main power supply for a portable electronic product including a mobile communications device, a notebook computer, or the like.

The electric double layer capacitor does not lead to \textcircled{1} an overcharge/overdischarge phenomenon to thereby simplify electrical circuits and lower product prices, may determine \textcircled{2} residual capacity from voltage, may indicate \textcircled{3} a wide range of temperature endurance characteristics (−30˜+90° C.), and \textcircled{4} may be made of eco-friendly materials, or the like, all of which are advantages that are not present in a capacitor and a secondary battery.

As the size of electronic products is reduced, it is essential to miniaturize various electronic components mounted in the electronic products and manufacture them in chip form. In order to expand the use of the electric double layer capacitor to a wide variety of applications, including a chip-type and a coin-type EDLC, there is a need to implement high energy density and low equivalent series resistance (ESR).

Generally, in the case of medium-large sized products, low ESR can be implemented by increasing the capacity thereof, while in the case of small products having a limited size, contact resistance is increased with the reduction of size. Therefore, it is common to implement low ESR while lowering capacity by changing the structure and thickness of an electrode.

Further, when an electrode is thick, the amount of a binder used in the manufacturing thereof should be increased in order to increase adhesion, which leads to a corresponding increase in resistance.

### SUMMARY OF THE INVENTION

An aspect of the present invention provides an electrode for an energy storage device having low resistance, a method of manufacturing the same, and an energy storage device using the same.

According to an aspect of the present invention, there is provided an electrode for an energy storage device, including: a metal layer having a dendrite formed on one surface thereof; and electrode materials formed on one surface of the metal layer.

The metal layer may be copper or aluminum.

The electrode materials may include an active material and a conductive material.

The electrode materials may further include a binder.

The active material may include at least one selected from a group consisting of activated carbon powder, carbon nano tube, graphite, vapor grown carbon fiber, carbon aerogel, carbon nanofiber produced by carbonizing polymers such as polyacrylonitrile and polyvinylidenefluoride, and activated carbon nanofiber.

The conductive material may be carbon black.

The binder may include at least one selected from a group consisting of carboxymethyl cellulose, polyvinylidene fluoride-co-hexa fluoropropylenes, fluorinated poly tetra fluoroethylene, and rubber-based styrene butadiene rubber.

According to another aspect of the present invention, there is provided a method of manufacturing an electrode for an energy storage device, including: a first step of preparing a metal layer having a dendrite formed thereon; and a second step of applying an electrode material slurry to the metal layer having the dendrite formed thereon.

The metal layer may be copper or aluminum.

The electrode materials may include an active material and a conductive material.

The electrode materials may further include a binder.

The second step may be replaced with replaced with forming an electrode material sheet with the electrode material slurry; and attaching the electrode material sheet to the metal layer having the dendrite formed thereon.

The active material may include at least one selected from a group consisting of activated carbon powder, carbon nano tube, graphite, vapor grown carbon fiber, carbon aerogel, carbon nanofiber produced by carbonizing polymers such as polyacrylonitrile and polyvinylidenefluoride, and activated carbon nanofiber.

The conductive material may be carbon black.

The binder may include at least one selected from the group consisting of carboxymethyl cellulose, polyvinylidene fluoride-co-hexa fluoropropylenes, fluorinated poly tetra fluoroethylene, and rubber-based styrene butadiene rubber.

According to an aspect of the present invention, there is provided an energy storage device, including: a first electrode and a second electrode disposed to be spaced apart from each other in order to face each other; and a separator disposed between the first and second electrodes to separate the first and second electrodes, wherein at least one of the first and second electrodes includes a metal layer having a dendrite formed on one surface thereof and electrode materials formed on one surface of the metal layer.

The metal layer may be copper or aluminum.

The electrode materials may include an active material and a conductive material.

The electrode materials may further include a binder.

The active material may include at least one selected from a group consisting of activated carbon powder, carbon nano tube, graphite, vapor grown carbon fiber, carbon aerogel, carbon nanofiber produced by carbonizing polymers such as polyacrylonitrile and polyvinylidenefluoride, and activated carbon nanofiber.

The conductive material may be carbon black.

The binder may include at least one selected from a group consisting of carboxymethyl cellulose, polyvinylidene fluoride-co-hexa fluoropropylenes, fluorinated poly tetra fluoroethylene, and rubber-based styrene butadiene rubber.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram schematically showing a structure of an electric double layer capacitor according to an exemplary embodiment of the present invention;

FIG. 2 is a cross-sectional view of a metal layer formed with dendrites according to an exemplary embodiment of the present invention;

FIG. 3 is a flow chart showing a process of manufacturing an electrode for an energy storage device according to an exemplary embodiment of the present invention; and

FIG. 4 is a diagram showing charge and discharge principles of an electric double layer capacitor according to an exemplary embodiment of the present invention.

### DETAILED DESCRIPTION OF THE PREFERRED EMBODIMENT

Exemplary embodiments of the present invention will be described with reference to the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

An electrode for an energy storage device according to an exemplary embodiment of the present invention may be configured to include a metal layer having dendrites formed on one surface thereof and an electrode material formed on one surface of the metal layer.

An example of the energy storage device may include a capacitor, a secondary battery, an electric double layer capacitor, or the like. The electrode for the energy storage device refers to an electrode that can be used as an electrode in the energy storage device. The exemplary embodiment of the present invention will describe, byway of example, an electric double layer capacitor among the energy storage devices.

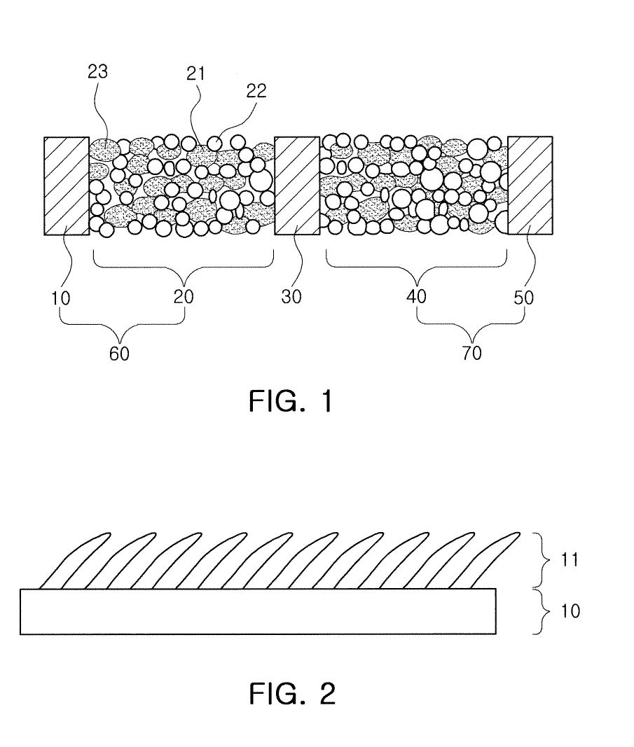

FIG. 1 is a diagram schematically showing a structure of an electric double layer capacitor according to an exemplary embodiment of the present invention.

Referring to FIG. 1, the electric double layer capacitor may be configured to include a first electrode 60, a second electrode 70, and a separator 30. The first electrode 60 and the second electrode 70 are isolated by the separator 30.

The first electrode 60 may be configured to include a metal layer 10 and electrode materials 20, and the electrode materials 20 may be configured to include an active material 21, a conductive material 22, and a binder 23.

The electric double layer capacitor is a capacitor storing electrical energy through an electrostatic charge phenomenon that is generated from an electric double layer formed at an interface between an electrode 60 and an electrolyte (not shown).

The equivalent series resistance (ESR) characteristics of the energy storage device are largely changed according to a contact state between the metal layer 10 and the electrode materials 20. That is, as a contact area between the metal layer 10 and the electrode materials 20 is increased, the ESR becomes smaller, such that the energy storage device may exhibit more excellent characteristics.

The metal layer 10 is a path through which external voltage is applied to the capacitor when the capacitor is charged and is a path through which a charge moves from the capacitor to external load when the capacitor is discharged.

The metal layer 10 may be made of gold (Au), platinum (Pt), titanium (Ti), copper (Cu), nickel (Ni), aluminum (Al), or the like, all of which do not participate in electrode reaction, are electrochemically stable, and have excellent electric conductivity.

However, in consideration of manufacturing processes and costs, a copper (Cu) or aluminum (Al) foil may be used.

A dendrite 11 may be formed on one surface of the metal layer 10.

FIG. 2 shows a shape in which the dendrites are formed on a surface of the metal layer 10. FIG. 2 exaggeratedly shows the dendrites as if the dendrites are spaced by a predetermined distance in order to assist to understand the structure of the metal layer formed with the dendrites.

Generally, the surface area of the metal layer 10 is increased by roughening the surface of the metal layer 10 or forming the ruggedness on the surface of the metal layer 10. Increasing the surface area of the metal layer 10 is to increase the contact area between the electrode 20 and the metal layer 10.

As the contact area between the electrode materials 20 and the metal layer 10 is increased, the contact resistance between the electrode materials 20 and the metal layer 10 is reduced and adhesion between electrode materials 20 and the metal layer 10 is also increased.

In the exemplary embodiment of the present invention, the surface area of the metal layer 10 is increased by forming the dendrite 11 on the surface of the metal layer 10.

In this case, a dendrite refers to a dendritic crystal. The formation of the dendrite 11 may be easily observed during a process of solidifying a metal molten liquid.

During the process of solidifying the molten liquid, a crystalline nucleus is first generated and the crystalline nucleus grows up to be a large crystal. The crystal is grown to have a twig-like shape due to the difference in growth rate during the growing of the crystal, which is referred to as the dendrite.

Since the dendrite 11 has a twig-like structure, the surface area of the metal layer 10 may be increased when the structure of the dendrite 11 is formed on the surface of the metal layer 10. As a result, the contact area between the metal layer 10 and the electrode materials 20 may be increased.

Further, a binder 23 may not be added as a component of the electrode material at the time of manufacturing the electrode materials.

Adding the binder 23 is to improve the adhesion between the metal layer 10 and the electrode materials 20. When the surface of the metal layer 10 is entangled with twig-like shapes due to the formation of the dendrite 11, the electrode materials 20 are penetrated between the twig-like shapes of the dendrite 11, such that the adhesion between the metal layer 10 and the electrode materials 20 may be maintained, without adding the binder 23. Further, the entire resistance of the capacitor may be lowered since the resistance component occurring due to the binder 23 may be removed by not adding the binder 23 that is an electrical non-conductor.

The dendrite 11 may be made of the same material as that of the metal layer 10. That is, the dendrite 11 may be made of copper or aluminum. Forming the dendrite 11 made of the same material as that of the metal layer 10 may allow for a firm connection between the dendrite 11 and the metal layer.

After the dendrite 11 is formed on the surface of the metal layer 10, the following effects can be obtained when the contact area between the metal layer 10 and the electrode materials 20 is increased by contacting the metal layer 10 with the electrode materials 20. First, the adhesion between the metal layer 10 and the electrode materials 20 may be largely increased. Second, the contact resistance between the metal layer 10 and the electrode materials 20 may be lowered.

An electrode refers to a terminal through which current flows. Anode is a terminal through which current flows out from a power supply, and cathode is a terminal through which current into a power supply.

The electrode 20 according to the exemplary embodiment of the present invention may include the metal layer 10 and the electrode materials 20. The electrode materials 20 may include the active material 21, the conductive material 22, and the binder 23.

The capacitance of the electric double layer capacitor maybe varied according to the structure and physical properties of the electrode material 20. That is, the capacitance of the electric double layer capacitor is large when the specific surface area of the electrode materials 20 is large, the internal resistance of the active material 21 is small, and the density of the electrode material 20 is high.

As the active material 21, a material having a large effective specific surface area may be used. An example of the active material may include activated carbon powder (ACP), carbon nano tube (CNT), graphite, vapor grown carbon fiber (VGCF), carbon aerogel, activated carbon nano fiber (ACNF), carbon nanofiber (CNF) produced by carbonizing polymers such as polyacrylonitrile (PAN) or polyvinylidenefluoride (PVdF), or the like.

The conductive material 22 refers to a material added to impart electric conductivity to the electrode materials 20. As the conductive material 22, a carbon black (CB), or the like, may be used.

The binder 23 refers to a material added for bonding between the active materials 21 and bonding between the metal layer 10 and the electrode materials 20.

An example of the binder 23 may include carboxymethyl cellulose (CMC), polyvinylidene fluoride-co-hexa fluoropropylenes (PVdF-co-HFP), fluorinated poly tetra fluoroethylene (PTFE) powder, emulsion, rubber-based styrene butadiene rubber, or the like, and the binder may be selectively used according to kinds of solvent.

The binder 23 is used to improve the bonding characteristic between the active material 21 and the metal layer 10 or between the active materials 21. However, since the binder 23 is a non-conductor unlike a carbon material that is the active material 21, the corresponding resistance is increased as the content of binder is increased.

Further, if the content of the binder 23 is excessively increased, the electrode materials 20 are brittle, such that workability thereof may be degraded.

Therefore, the smaller the content of the binder 23, the better the properties of the electrode materials is. In a view of the binder, the electric double layer capacitor not including the binder exhibits the most advantageous characteristics.

As described above, the electrode materials 20 may not include the binder 23 by sufficiently increasing the contact area between the electrode materials 20 and the metal layer 10 by forming the dendrite 11 on the surface of the metal layer 10.

The electrolyte 26 refers to a material that is melted in a solvent such as water, or the like, to be dissociated as ion, thereby allowing current to flow. An example of the electrolyte 26 may include an aqueous solution-based electrolyte in which a salt is melted.

For example, an electrolyte 26 including a sodium chloride solution, magnesium sulfate solution, a calcium sulfate solution, and mixture including two or more thereof may be used.

The separator 30 electrically separates the first electrode 60 and the second electrode 70. Since voltages having opposing polarities are applied to each of the first electrode 60 and the second electrode 70, the separator 30 is to prevent short-circuit by electrically separating the first electrode 60 and the second electrode 70.

An example of the separator 30 may include polypropylene, teflon, or the like.

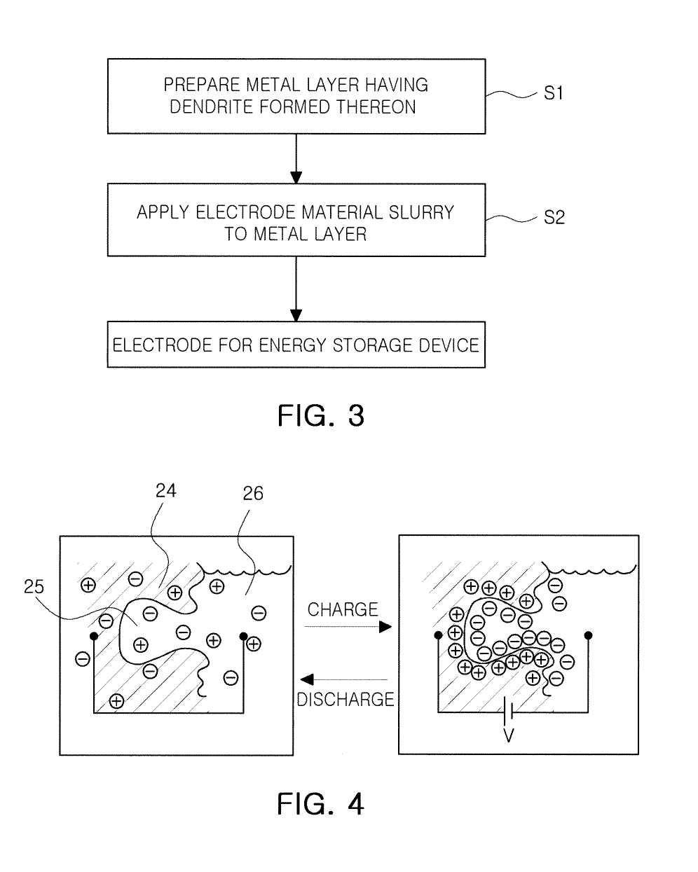

FIG. 3 is a flow chart showing a process of manufacturing an electrode for an energy storage device according to an exemplary embodiment.

A method of manufacturing the electrode for an energy storage device according to an exemplary embodiment of the present invention may include a first step of preparing the metal layer having the dendrite formed thereon and a second step of applying an electrode material slurry to the metal layer having the dendrite formed thereon.

The electrode for an energy storage device may be manufactured by applying the electrode material slurry to the metal layer 10 having the dendrite 11 formed thereon and then, drying the electrode material slurry. As described below, the electrode for an energy storage device may be manufactured by separately manufacturing the electrode material solid sheet and then, attaching the electrode material solid sheet to the metal layer 10.

The metal layer may be copper or aluminum.

The electrode materials may include the active material and the conductive material.

That is, this is the case in which the electrode materials 20 include only the active material 21 and the conductive material 22, without the binder 23, as the components of the electrode materials 20.

As described above, this case corresponds to the case in which the adhesion and the performance in contact resistance between the metal layer 10 and the electrode materials 20 are not degraded by maximizing the contact area between the metal layer 10 and the electrode materials 20 through the formation of the dendrite 11, even without using binder 23.

The electrode materials may further include the binder.

This corresponds to the case in which the electrode materials include the active material 21, the conductive material 22, and the binder 23 as components of the electrode materials. However, even in this case, the amount of the binder 23 may be reduced by forming the dendrite 11 on the surface of the metal layer 10, such that the adhesion improvement and the low resistance between the metal layer 10 and the electrode materials 20 may be accomplished.

The second step may be replaced with steps of forming an electrode material sheet with the electrode material slurry and attaching the electrode material sheet to the metal layer having the dendrite formed thereon.

This implies that the electrode material sheet is separately manufactured by using the slurry of the electrode materials 20 and the electrode material sheet is attached to the metal layer 10 having the dendrite 11 formed thereon by an adhesive, or the like.

The method of separately manufacturing the sheet of the electrode material 20 sheet and attaching the sheet to the metal layer 10 is more advantageous than the method of manufacturing the electrode 60 by applying the slurry of the electrode materials 20 to the metal layer 10 having the dendrite 11 formed thereon.

When the electrode 60 is manufactured by applying the slurry of electrode materials 20 to the metal layer 10, the slurry of the electrode materials 20 needs to be directly treated. However, the slurry of the electrode materials 20 is not easy to be directly treated during the manufacturing process of the electrode.

In the exemplary embodiment of the present invention, the descriptions with regard to the metal layer 10, the active material 21, the conductive material 22, or the like, are the same as the foregoing descriptions.

The energy storage device according to the exemplary embodiment of the present invention may be configured to include the first electrode and the second electrode disposed to be spaced apart from each other in order to face each other, and the separator disposed between the first and second electrodes to separate the first and second electrodes, wherein at least any one of the first and second electrodes includes the metal layer having the dendrite formed on one surface thereof and the electrode materials formed on one surface of the metal layer.

Referring to FIG. 1, the entire of the metal layer 10 and the electrode materials 20 are referred to as the first electrode 60 and the entire of the metal layer 50 and the electrode material 40 are referred to as the second electrode 70.

The first electrode 60 and the second electrode 70 are disposed to be spaced apart from each other, and the electrode materials 20 and 40 are faced to each other. The separator 30 is disposed between the first electrode 60 and the second electrode 70 and the first electrode 60 and the second electrode 70 are separated by the separator 30.

The metal layer 10 may be copper or aluminum.

The electrode material 20 may include the active material 21 and the conductive material 22.

The electrode material 20 may further include the binder 23.

In the exemplary embodiment of the present invention, the descriptions of the active material, the conductive material, the binder, or the like, are the same as the foregoing description.

FIG. 4 is a diagram schematically showing an operational principle of an electric double layer capacitor according to the exemplary embodiment of the present invention. The charge and discharge process of the electric double layer capacitor will be described with reference to FIG. 4.

As the active material 21, an active carbon 24 is used, wherein the active carbon 24 is provided with numerous pores 25. The electrolyte 26 is impregnated in the pores 25.

First, when DC voltage is applied to the electrodes 60 and 70, an anion in the electrolyte 26 is electrostatically induced to an electrode polarized into (+) and a cation in the electrolyte 26 is electrostatically induced to an electrode polarized into (−) to be adsorbed into the active material 21 of each electrode material 20, thereby forming the electric double layer at the interface between the active material 21 and the electrolyte 26.

That is, if (−) voltage is applied to a porous active carbon 24 formed having micro pores formed therein, (+) ion dissociated from the electrolyte 26 enters into the pores 25 of the active carbon 24 to form a (+) layer, such that the electric double layer having a (+) layer and a (−) layer is formed based on the interface between the active carbon 24 and the electrolyte 26.

As described above, the electric double layer capacitor generates only a physical reaction, without a chemical reaction at the interface between the active material 21 and the electrolyte 26. As a result, the electric double layer capacitor has more advantages than other batteries.

Charges are stored at the interface of the active material 21 according to the above-mentioned method. In particular, the electrode materials 20 are made of porous materials, such that the specific surface area of the electrode materials is very large, to thereby remarkably increase the charge storage.

According to the above-mentioned principle, the electric double layer stores electrical energy, which is referred to as charging. If the charging is completed, current does not flow in the electric double layer capacitor any more.

Next, when a circuit (not shown) connecting the first and second electrodes 60 and 70 and a load (not shown is formed in the outside of the capacitor, the charge charged at the interface between the active material 21 and the electrolyte 26 moves to the load along a conducting wire and ions forming the electric double layer within the electrolyte 26 impregnated in the pores 25 of the active carbon 24 moves out from the pores, such that the electric double layer disappears.

Consequently, the electric energy stored in the electric double layer is consumed by the load, and is converted into another energy. This is referred to as discharging.

The electrode materials 20 gradually lose polarities thereof at the time of discharging and the ions adsorbed into the pores 25 of the active carbon 24 are desorbed. Therefore, the active carbon 24 again recovers activity of the surface thereof.

The electric double layer capacitor uses the physical adsorption and desorption principles of ions on the surface of the active carbon 24, such that it has a high output, high charge and discharge efficiency, and is semi-permanent.

While the present invention has been shown and described in connection with the exemplary embodiments, it will be apparent to those skilled in the art that modifications and variations can be made without departing from the spirit and scope of the invention as defined by the appended claims.

What is claimed is:

1. An electrode for an energy storage device, comprising:
a metal layer having a dendrite formed on one surface thereof; and
electrode materials formed on one surface of the metal layer.

2. The electrode of claim 1, wherein the metal layer is copper or aluminum.

3. The electrode of claim 1, wherein the electrode materials include an active material and a conductive material.

4. The electrode of claim 3, wherein the electrode materials further includes a binder.

5. The electrode for an energy storage device of claim 3, wherein the active material includes at least one selected from a group consisting of activated carbon powder, carbon nano tube, graphite, vapor grown carbon fiber, carbon aerogel, carbon nanofiber produced by carbonizing polymers such as polyacrylonitrile and polyvinylidenefluoride, and activated carbon nanofiber.

6. The electrode of claim 3, wherein the conductive material is carbon black.

7. The electrode of claim 4, wherein the binder includes at least one selected from a group consisting of carboxymethyl cellulose, polyvinylidene fluoride-co-hexa fluoropropylenes, fluorinated poly tetra fluoroethylene, and rubber-based styrene butadiene rubber.

8. A method of manufacturing an electrode for an energy storage device, comprising:
a first step of preparing a metal layer having a dendrite formed thereon; and
a second step of applying an electrode material slurry to the metal layer having the dendrite formed thereon.

9. The method of claim 8, wherein the metal layer is copper or aluminum.

10. The method of claim 8, wherein the electrode materials include an active material and a conductive material.

11. The method of claim 10, wherein the electrode materials further includes a binder.

12. The method of claim 8, wherein the second step is replaced with forming an electrode material sheet with the electrode material slurry; and attaching the electrode material sheet to the metal layer having the dendrite formed thereon.

13. The method of claim 10, wherein the active material includes at least one selected from a group consisting of activated carbon powder, carbon nano tube, graphite, vapor grown carbon fiber, carbon aerogel, carbon nanofiber produced by carbonizing polymers such as polyacrylonitrile and polyvinylidenefluoride, and activated carbon nanofiber.

14. The method of claim 10, wherein the conductive material is carbon black.

15. The method of claim 11, wherein the binder includes at least one selected from the group consisting of carboxymethyl cellulose, polyvinylidene fluoride-co-hexa fluoropropylenes, fluorinated poly tetra fluoroethylene, and rubber-based styrene butadiene rubber.

16. An energy storage device, comprising:
a first electrode and a second electrode disposed to be spaced apart from each other in order to face each other; and
a separator disposed between the first and second electrodes to separate the first and second electrodes,
wherein at least one of the first and second electrodes includes a metal layer having a dendrite formed on one surface thereof and electrode materials formed on one surface of the metal layer.

17. The energy storage device of claim 16, wherein the metal layer is copper or aluminum.

18. The energy storage device of claim 16, wherein the electrode materials include an active material and a conductive material.

19. The energy storage device of claim 16, wherein the electrode materials further include a binder.

20. The energy storage device of claim 18, wherein the active material includes at least one selected from a group consisting of activated carbon powder, carbon nano tubes, graphite, vapor grown carbon fiber, carbon aerogel, carbon nanofiber produced by carbonizing polymers such as polyacrylonitrile and polyvinylidenefluoride, and activated carbon nanofiber.

21. The energy storage device of claim 18, wherein the conductive material is carbon black.

22. The energy storage device of claim 19, wherein the binder includes at least one selected from a group consisting of carboxymethyl cellulose, polyvinylidene fluoride-co-hexa fluoropropylenes, fluorinated poly tetra fluoroethylene, and rubber-based styrene butadiene rubber.
